(19) United States
(12) Patent Application Publication
(10) Pub. No.: US 2022/0098040 A1
(43) Pub. Date: Mar. 31, 2022

(54) Cellulose Nanofiber Carbon and Method for Producing Same

(71) Applicant: Nippon Telegraph and Telephone Corporation, Tokyo (JP)

(72) Inventors: Masaya Nohara, Musashino-shi, Tokyo (JP); Mikayo Iwata, Musashino-shi, Tokyo (JP); Hironobu Minowa, Musashino-shi, Tokyo (JP); Shuhei Sakamoto, Musashino-shi, Tokyo (JP); Takeshi Komatsu, Musashino-shi, Tokyo (JP)

(21) Appl. No.: 17/423,392

(22) PCT Filed: Dec. 27, 2019
(86) PCT No.: PCT/JP2019/051445

§ 371 Date: Nov. 30, 2021

(30) Foreign Application Priority Data
Jan. 16, 2019 (JP) 2019-005314

(51) Int. Cl. C01B 32/05; D01F 9/16

(52) U.S. Cl. CPC C01B 32/05; C01P 2004/03; D01F 9/16

(57) ABSTRACT

Provided are cellulose nanofiber carbon having elasticity, high mechanical strength, and capable of increasing its specific surface area, and a method for producing the same. A method for producing cellulose nanofiber carbon by carbonizing cellulose nanofibers, includes a semi-carbonization step S2 of semi-carbonizing a dispersion liquid or gel containing cellulose nanofibers with a heat medium to obtain a semi-carbonized body, and a carbonization step S3 of heating and carbonizing the semi-carbonized body in an atmosphere that does not burn the semi-carbonized body to obtain cellulose nanofiber carbon.

### TECHNICAL FIELD

The present invention relates to cellulose nanofiber carbon and a method for producing the same.

### BACKGROUND ART

Carbon nanofibers are fibrous, generally having an outer diameter of 5 to 100 nm, and the fiber length equal to or more than 10 times as long as the outer diameter. Due to its unique shape, it has features such as high conductivity and high specific surface area.

In related art, as a method for producing carbon nanofibers, for example, an electrode discharge method, a vapor phase growth method, and a laser method are known (Non Patent Literatures 1 and 2).

### CITATION LIST

### Non Patent Literature

Non Patent Literature 1: S. A. Iijima et al. “Single-shell carbon nanotubes”, Nature, Vol. 363, 17 Jun. 1993.

Non Patent Literature 2: J. Mol. Kong et al. “Chemical vapor deposition of methane for single-walled carbon nanotubes”, Chemical Physics Letters 292, 567-574, 1998.

### SUMMARY OF THE INVENTION

### Technical Problem

Carbon nanofibers produced by a related-art production method have a problem in that they have no elasticity, are plastically deformed so that they cannot return to their original shape due to compression or bending, and have low mechanical strength.

In addition, a method for producing cellulose nanofibers from cellulose derived from natural products is also being studied, but when the cellulose nanofibers are heat-treated to obtain a carbon material, the cellulose nanofibers aggregate during being dried and are sintered during the heat treatment, and the obtained carbon material has a high density and is difficult to have a large specific surface area.

The present invention has been made in view of this problem, and an object of the present invention is to provide cellulose nanofiber carbon having elasticity, high mechanical strength, and capable of increasing its specific surface area, and a method for producing the same.

### Means for Solving the Problem

The method for producing cellulose nanofiber carbon according to an aspect of the present invention includes semi-carbonizing a dispersion liquid or gel containing cellulose nanofibers with a heat medium to obtain a semi-carbonized product; and heating and carbonizing the semi-carbonized product in an atmosphere that does not burn the semi-carbonized product to obtain cellulose nanofiber carbon.

The cellulose nanofiber carbon according to an aspect of the present invention has a three-dimensional network structure of a co-continuous body in which cellulose nanofibers are connected.

The cellulose nanofiber carbon according to an aspect of the present invention has a three-dimensional network structure of a co-continuous body in which bacterial gel nanofibers are connected.

### Effects of the Invention

The present invention provides cellulose nanofiber carbon having elasticity and high mechanical strength and capable of increasing its specific surface area, and a method for producing the same.

### BRIEF DESCRIPTION OF DRAWINGS

FIG. 1 is a flowchart depicting a method for producing cellulose nanofiber carbon according to a first embodiment of the present invention.

FIG. 2A is a scanning electron microscope (SEM) image of cellulose nanofiber carbon produced by the production method of the first embodiment.

FIG. 2B is an SEM image of a carbon material produced by a production method different from that of the first embodiment.

FIG. 3 is an SEM image of cellulose nanofiber carbon produced by the production method of a modification of the first embodiment.

FIG. 4 is a flowchart depicting a method for producing cellulose nanofiber carbon according to a second embodiment of the present invention.

FIG. 5A is an SEM image of the skin portion of the carbon material obtained in Experimental Example 1.

FIG. 5B is an SEM image of a cross section of the carbon material of Experimental Example 1 obtained in Experimental Example 3.

FIG. 5C is an SEM image of the carbon material obtained in Experimental Example 2.

FIG. 5D is an SEM image of the skin portion of the carbon material obtained in Experimental Example 4.

FIG. 5E is an SEM image of a cross section of the carbon material of Experimental Example 4 obtained in Experimental Example 6.

FIG. 5F is an SEM image of the carbon material obtained in Experimental Example 5.

FIG. 5G is an SEM image of the carbon material obtained in Comparative Example 1.

FIG. 5H is an SEM image of the carbon material obtained in Comparative Example 2.

FIG. 6 is a flowchart depicting a method for producing bacterial cellulose carbon according to a third embodiment of the present invention.

FIG. 7A is an SEM image of bacterial cellulose carbon produced by the production method of the third embodiment.

FIG. 7B is an SEM image of a carbon material produced by a production method different from that of the third embodiment.

FIG. 8 is an SEM image of bacterial cellulose carbon produced by the production method of a modification of the third embodiment.

FIG. 9 is a flowchart depicting a method for producing bacterial cellulose carbon according to a fourth embodiment of the present invention.

FIG. 10A is an SEM image of the skin portion of the carbon material obtained in Experimental Example 1.

FIG. 10B is an SEM image of a cross section of the carbon material of Experimental Example 1 obtained in Experimental Example 3.

FIG. 10C is an SEM image of the carbon material obtained in Experimental Example 2.

FIG. 10D is an SEM image of the skin portion of the carbon material obtained in Experimental Example 4.

FIG. 10E is an SEM image of a cross section of the carbon material of Experimental Example 4 obtained in Experimental Example 6.

FIG. 10F is an SEM image of the carbon material obtained in Experimental Example 5.

FIG. 10G is an SEM image of the carbon material obtained in Comparative Example 1.

FIG. 10H is an SEM image of the carbon material obtained in Comparative Example 2.

### DESCRIPTION OF EMBODIMENTS

Embodiments of the present invention will be described with reference to the drawings.

### First Embodiment

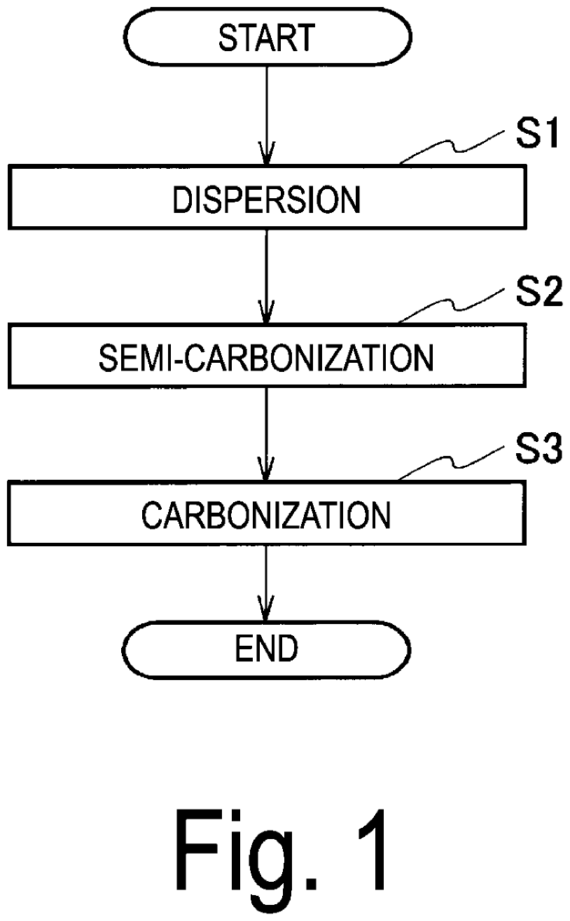

FIG. 1 is a flowchart depicting a method for producing cellulose nanofiber carbon according to the first embodiment of the present invention. In the following description, cellulose nanofiber carbon may be referred to as “carbon material”.

The method for producing cellulose nanofiber carbon of the present embodiment includes a dispersion step (step S1), a semi-carbonization step (step S2), and a carbonization step (step S3). In this production method, a dispersion liquid containing cellulose nanofibers (hereinafter, referred to as “cellulose nanofiber dispersion liquid”) is required.

The form of the cellulose nanofibers in the cellulose nanofiber dispersion liquid is preferably a dispersed form. Therefore, the production process depicted in FIG. 1 includes a dispersion step (step S1), but the dispersion step (step S1) may be omitted. That is, when the cellulose nanofiber dispersion liquid in which the cellulose nanofibers are dispersed is used, the step is not necessary.

In the dispersion step, the cellulose nanofibers contained in the cellulose nanofiber dispersion liquid are dispersed. The dispersion medium may be one or a mixture of two or more of aqueous ones such as (H₂O) and organic ones such as carboxylic acid, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, and glycerin.

For the dispersion of the cellulose nanofibers, for example, a homogenizer, an ultrasonic cleaner, an ultrasonic homogenizer, a magnetic stirrer, a stirrer, or a shaker may be used.

The solid content concentration of the cellulose nanofibers in the cellulose nanofiber dispersion liquid is preferably from 0.001 to 80% by mass, and more preferably from 0.01 to 30% by mass.

In the semi-carbonization step, a semi-carbonized product is obtained by impregnating a heat medium with a cellulose nanofiber dispersion liquid (step S2). The chemical composition of cellulose is (C₆H₁₀O₅)n, and by performing the heat treatment, the dehydration reaction proceeds, and finally carbon remains. The semi-carbonized product refers to a product obtained by terminating the above dehydration reaction in the middle and removing a part of OH groups from cellulose. In the present embodiment, the semi-carbonized product is defined in this way.

In the semi-carbonization step, for example, the cellulose nanofiber dispersion liquid is impregnated in silicone oil heated to 250° C., the dispersion medium contained in the cellulose nanofiber dispersion liquid is vaporized, and then the heat treatment is continued. The method of semi-carbonization is not particularly limited as long as it can semi-carbonize the cellulose nanofibers. The heat medium may be one or a mixture of two or more of silicone oils, polyhydric alcohols, phenols, phenolic ethers, polyphenyls, chlorinated benzene, and polyphenyls, siliceous esters, distilled tars, and petroleum, edible oils, and the like.

The temperature of the heat medium varies depending on the heat medium used, but is not particularly limited as long as the cellulose nanofibers are semi-carbonized at the temperature. For example, when silicone oil is used as the heat medium and water is used as the dispersion medium for the cellulose nanofiber dispersion liquid, impregnating the cellulose nanofiber dispersion liquid with silicone oil at 200° C. causes the water in the dispersion medium to be rapidly vaporized, and then the semi-carbonization of the cellulose nanofibers is started. Since the semi-carbonization temperature of the cellulose nanofibers is about 200° C., the temperature of the heat medium is preferably 200° C. or higher.

Further, after semi-carbonization, since the heat medium is contained in the semi-carbonized cellulose nanofibers, a cleaning step of cleaning with water, alcohol or the like may be included.

Since the semi-carbonized product has elasticity, when the semi-carbonized product is dried, even if it is affected by the surface tension of the liquid, it can maintain its original shape (three-dimensional network structure in which cellulose nanofibers, which are dispersoids, are fixed) without aggregation.

In the carbonization step, the semi-carbonized product which has been semi-carbonized in the semi-carbonization step is heated and carbonized in an atmosphere that does not burn the semi-carbonized product, thereby obtaining cellulose nanofiber carbon (step S3). Carbonization of cellulose nanofibers may be carried out by firing at 200° C. to 2000° C., more preferably from 600° C. to 1800° C. in an inert gas atmosphere. The gas that does not burn cellulose may be, for example, an inert gas such as nitrogen gas or argon gas. Further, the gas that does not burn cellulose may be a reducing gas such as hydrogen gas or carbon monoxide gas, or may be carbon dioxide gas. Carbon dioxide gas or carbon monoxide gas, which has an activating effect on carbon materials and can be expected to be highly activated, is more preferable.

According to the method for producing cellulose nanofiber carbon described above, the cellulose nanofibers which are dispersoids are fixed by the semi-carbonization step, and the cellulose nanofibers maintaining the three-dimensional network structure can be taken out. Therefore, a sufficient specific surface area can be obtained, and a carbon material having a high specific surface area can be easily produced.

That is, the cellulose nanofiber carbon produced in the present embodiment has a three-dimensional network structure of a co-continuous body in which a plurality of cellulose nanofibers integrated by non-covalent bonds are connected. The co-continuous body is a porous body and has an integral structure. The co-continuous body of the three-dimensional network structure in which a plurality of cellulose nanofibers are integrated by non-covalent bonds has an elastic structure in which the bonding portion between the cellulose nanofibers is deformable.

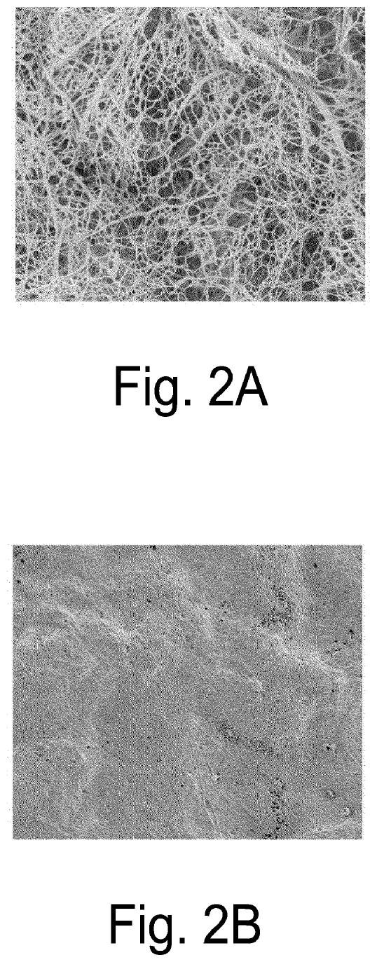

FIGS. 2A and 2B are scanning electron microscope (SEM) images of cellulose nanofiber carbon. The magnification is 10,000 times.

FIG. 2A is an SEM image of cellulose nanofiber carbon produced by the production method of the present embodiment. The image shows that the cellulose nanofibers are fixed and a three-dimensional network structure is constructed.

FIG. 2B shows the state of cellulose nanofiber carbon when the cellulose nanofiber dispersion liquid is dried in the air and carbonized, unlike the production method of the present embodiment. During drying, the dispersion liquid in which the cellulose nanofibers are dispersed is affected by the surface tension of the dispersion medium, and the unimmobilized cellulose nanofibers aggregate, so that the three-dimensional network structure of the cellulose nanofibers is destroyed. As shown in FIG. 2B, if the three-dimensional network structure is destroyed, it is difficult to prepare a carbon material having a high specific surface area.

As described above, the cellulose nanofiber carbon produced by the production method of the present embodiment is a carbon material having a three-dimensional network structure of a co-continuous body in which cellulose nanofibers are connected and having elasticity. Further, the cellulose nanofiber carbon of the present embodiment has high conductivity, corrosion resistance, and a high specific surface area.

Therefore, the cellulose nanofiber carbon produced by the production method of the present embodiment is suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbents, heating elements, microwave heating elements, cone paper, clothes, carpets, mirror anti-fog materials, sensors, and touch panels.

### Modification of First Embodiment

The method for producing cellulose nanofiber carbon in the present modification is the same as that in the first embodiment, except that hot water at high temperature and high pressure is used as the heat medium used in the semi-carbonization step in the production method of the first embodiment depicted in FIG. 1.

Specifically, as depicted in FIG. 1, the method for producing cellulose nanofiber carbon in the present modification includes a dispersion step (step S1), a semi-carbonization step (step S2), and a carbonization step (step S3). Since the dispersion step and the carbonization step are the same as those in the first embodiment, description thereof will be omitted here.

In the semi-carbonization step in the present modification, a semi-carbonized product is obtained by impregnating the cellulose nanofiber dispersion liquid with hot water (high temperature and high pressure water) which is a heat medium (high temperature and high pressure water) (step S2).

The semi-carbonization step in the present modification is carried out, for example, by placing a cellulose nanofiber dispersion liquid in a hydrothermal synthesis container, self-pressurizing it, and heat-treating it at 250° C. The method for semi-carbonization is not particularly limited as long as it can semi-carbonize the cellulose nanofibers. However, since the semi-carbonization temperature of the cellulose nanofibers is about 200° C., the temperature is preferably 200° C. or higher.

Since the semi-carbonized product has elasticity, it is possible to maintain the original shape without aggregation even if it is affected by the surface tension of the liquid when the semi-carbonized product is dried.

According to the method for producing cellulose nanofiber carbon in the present modification, the cellulose nanofibers which are dispersoids are fixed by the semi-carbonization step, and the cellulose nanofibers that maintain the three-dimensional network structure can be taken out. Therefore, a sufficient specific surface area can be obtained, and a carbon material having a high specific surface area can be easily produced.

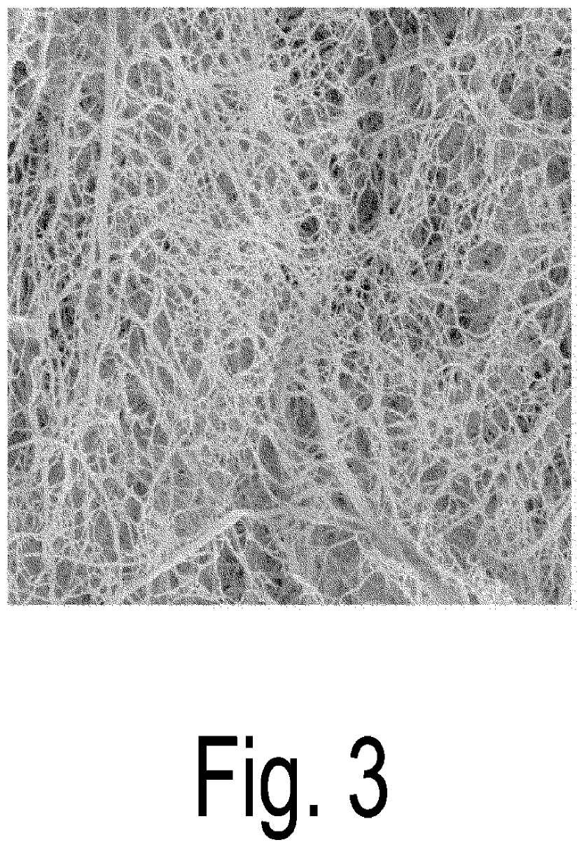

FIG. 3 is an SEM image of cellulose nanofiber carbon produced by the production method of the present modification. The magnification is 10,000 times. The image shows that the cellulose nanofibers are fixed and a three-dimensional network structure is constructed.

The cellulose nanofiber carbon produced by the production method in the present modification is a carbon material having a three-dimensional network structure of a co-continuous body in which cellulose nanofibers are connected and having elasticity, as in the first embodiment. Further, the cellulose nanofiber carbon of the present modification has high conductivity, corrosion resistance, and a high specific surface area, as in the first embodiment.

Therefore, the cellulose nanofiber carbon produced by the production method of the present modification is suitable for use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbents, heating elements, microwave heating elements, cone paper, clothes, carpets, mirror anti-fog materials, sensors, and touch panels.

### Second Embodiment

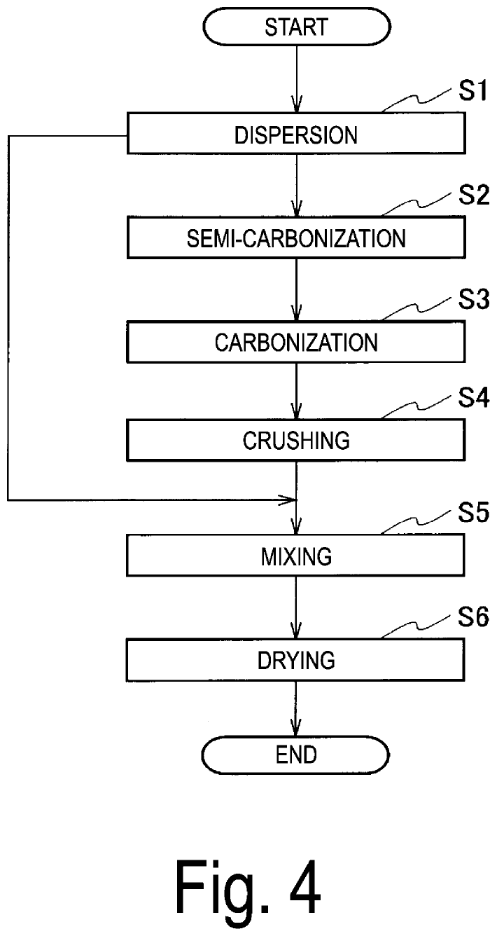

FIG. 4 is a flowchart depicting a method for producing cellulose nanofiber carbon according to the second embodiment. The production method depicted in FIG. 4 further includes a crushing step (step S4 ), a mixing step (step S5), and a drying step (step S6) in the production method of the first embodiment.

In the crushing step, the dried body (cellulose nanofiber carbon) carbonized in the above carbonization step (step S3) is crushed (step S4 ). In the crushing step, the cellulose nanofiber carbon is crushed into powder or slurry using, for example, a mixer, a homogenizer, an ultrasonic homogenizer, a high-speed rotary shear type stirrer, a colloid mill, a roll mill, a high-pressure injection disperser, a rotary ball mill, a vibrating ball mill, a planetary ball mill, or an attritor.

In this case, the cellulose nanofiber carbon preferably has a secondary particle diameter of from 10 nm to 20 mm, more preferably from 50 nm to 1 mm The reason for this is as follows: when cellulose carbon is crushed to a secondary particle size of 10 nm or less, the co-continuous structure of cellulose nanofibers is broken, it becomes difficult to obtain sufficient binding force and conductive path, and electrical resistance increases. Further, when the secondary particle diameter is 20 mm or more, the cellulose nanofibers functioning as a binder are not sufficiently dispersed, and it becomes difficult to maintain the sheet shape.

Further, since the cellulose nanofiber carbon has a high porosity and a low density, when the cellulose nanofiber carbon is crushed alone, the cellulose nanofiber carbon powder flies during or after the crushing, which makes it difficult to handle. Therefore, it is preferable to impregnate the cellulose nanofiber carbon with a liquid and then crushed it. The liquid used herein is not particularly limited, and may, for example, be one or a mixture of two or more of aqueous ones such as (H₂O) and organic ones such as carboxylic acid, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, and glycerin.

In the mixing step, the material (cellulose nanofiber carbon) crushed in the crushing step (step S4 ) and the cellulose nanofiber dispersion liquid dispersed in the dispersion step (step S1) are mixed to obtain a mixed solution (step S5). The mixed solution is in the form of a slurry, and by drying the mixed slurry, it is possible to process the cellulose nanofiber carbon into a sheet. The crushing step and the mixing step may be performed simultaneously as one step.

In the drying step, the liquid is removed from the mixed solution (step S6). When drying the slurry-like mixed solution (mixed slurry), a constant temperature bath, a vacuum dryer, an infrared dryer, a hot air dryer, a suction dryer, or the like may be used. Further, by performing suction filtration using an aspirator or the like, it can be dried quickly.

The mixed slurry obtained by the production method of the present embodiment described above may be dried, formed into a sheet, and then processed into a desired shape. Alternatively, the sheet-shaped carbon material may be processed into a desired shape by applying the mixed slurry to a predetermined shape and then drying it. By applying it to a predetermined shape, it is possible to reduce the material cost such as scraps generated by the cutting process, and it is possible to obtain a carbon material having a shape according to the user's preference. In addition, the strength of the carbon material can be increased.

The production method of the present embodiment does not have to include all the steps. For example, cellulose nanofiber carbon subjected to the crushing step may be used in a crushed state. The term “used” means to be distributed in that state. Similarly, cellulose nanofiber carbon subjected to the mixing step may be distributed in the state of a mixed slurry.

### Modification of Second Embodiment

The method for producing cellulose nanofiber carbon in the present modification is the same as that in the second embodiment, except that hot water at high temperature and high pressure is used as the heat medium used in the semi-carbonization step in the production method of the second embodiment depicted in FIG. 4.

Specifically, the method for producing cellulose nanofiber carbon in the present modification is the production method in the modification of the first embodiment using hot water at high temperature and high pressure as the heat medium in the semi-carbonization step, further including a crushing step (step S4 ), a mixing step (step S5), and a drying step (step S6).

The crushing step, mixing step, and drying step in the present modification are the same as those of the second embodiment. That is, in the crushing step in the present modification, the dried body (cellulose nanofiber carbon) carbonized in the carbonization step (step S3) of the modification of the first embodiment is crushed (step S4 ). In the mixing step, the material (cellulose nanofiber carbon) crushed in the crushing step (step S4 ) and the cellulose nanofiber dispersion liquid dispersed in the dispersion step (step S1) are mixed to form a slurry-like mixed solution (mixed slurry) (Step S5). The drying step removes liquid from the mixed solution (step S6).

The mixed slurry obtained by the production method in the present modification may be dried, formed into a sheet, and then processed into a desired shape. Alternatively, the sheet-shaped carbon material may be processed into a desired shape by applying the mixed slurry to a predetermined shape and then drying it. By applying it to a predetermined shape, it is possible to reduce the material cost such as scraps generated by the cutting process, and it is possible to obtain a carbon material having a shape according to the user's preference. In addition, the strength of the carbon material can be increased.

The production method in the present modification does not have to include all the steps. For example, cellulose nanofiber carbon subjected to the crushing step may be used in a crushed state. The term “used” means to be distributed in that state. Similarly, cellulose nanofiber carbon subjected to the mixing step may be distributed in the state of a mixed slurry.

### Experimental Examples of First Embodiment, Second Embodiment, and Modifications

For the purpose of confirming the effects of the production methods of the first embodiment and the second embodiment described above, an experiment was carried out for comparing the carbon material produced by the production methods of the first embodiment and the second embodiment (Experimental Examples 1 to 3) with the carbon materials produced by production methods different from the above embodiments (Comparative Examples 1 and 2). Further, the same experiment was also performed on the carbon materials (Experimental Examples 4 to 6) produced by the modification of the first embodiment and the modification of the second embodiment.

### Experimental Example 1

Experimental Example 1 is an experimental example of a carbon material (cellulose nanofiber carbon) prepared by the production method of the first embodiment (see FIG. 1).

Using cellulose nanofibers (manufactured by Nippon Paper Industries Co., Ltd.), 1 g of cellulose nanofibers and 10 g of ultrapure water were stirred with a homogenizer (manufactured by SMT Co., Ltd.) for 12 hours to prepare a dispersion liquid of cellulose nanofibers.

By immersing the dispersion liquid in silicone oil heated to 250° C. for 24 hours, the water contained in the cellulose nanofiber dispersion liquid was completely vaporized, and the cellulose nanofibers were semi-carbonized. After completely semi-carbonizing the cellulose nanofiber dispersion liquid, the semi-carbonized cellulose nanofibers were taken out and washed with ultrapure water.

After washing, the cellulose nanofibers were carbonized by firing at 600° C. for 2 hours in a nitrogen atmosphere, whereby the carbon material of Experimental Example 1 was prepared.

### Experimental Example 2

Experimental Example 2 is an experimental example of a carbon material (cellulose nanofiber carbon) prepared by the production method of the second embodiment (see FIG. 4).

In Experiment Example 2, water was impregnated with the carbon material prepared in Experimental Example 1, and then the carbon material and the cellulose nanofiber dispersion liquid (the weight ratio of the carbon material to cellulose nanofiber dispersion liquid was 1:1) were stirred with a homogenizer (manufactured by SMT Co., Ltd.) for 12 hours to crush and mix the mixture. Here, the crushing step (step S4 ) and the mixing step (step S5) of FIG. 4 were simultaneously performed in one step. This mixture (mixed solution) was in the form of a slurry, and was suction-filtered using an aspirator (manufactured by Shibata Scientific Technology Ltd.) to peel off the carbon material from the filter paper. Then, the carbon material was placed in a constant temperature bath and dried at 60° C. for 12 hours to prepare the carbon material of Experimental Example 2.

### Experimental Example 3

Experimental Example 3 is an experimental example of a carbon material (cellulose nanofiber carbon) prepared by the production method of the first embodiment (see FIG. 1).

In Experimental Example 3, the carbon material was prepared by peeling only the skin portion of the carbon material produced in Experimental Example 1 with a cutter or the like. That is, the surface of the carbon material prepared in Experimental Example 1 was removed to prepare the carbon material of Experimental Example 3.

### Experimental Example 4

Experimental Example 4 is an experimental example of a carbon material (cellulose nanofiber carbon) prepared by the production method of the modification of the first embodiment (see FIG. 1).

Using cellulose nanofibers (manufactured by Nippon Paper Industries Co., Ltd.), 1 g of cellulose nanofibers and 10 g of ultrapure water were stirred with a homogenizer (manufactured by SMT Co., Ltd.) for 12 hours to prepare a dispersion liquid of cellulose nanofibers.

The dispersion liquid was placed in a hydrothermal synthesis container and heated to 250° C. to semi-carbonize the cellulose nanofibers.

After semi-carbonization, the cellulose nanofibers were carbonized by firing at 600° C. for 2 hours in a nitrogen atmosphere, whereby the carbon material of Experimental Example 4 was prepared.

### Experimental Example 5

Experimental Example 5 is an experimental example of a carbon material (cellulose nanofiber carbon) prepared by the production method of the modification of the second embodiment (see FIG. 3).

In Experimental Example 5, after impregnating the carbon material produced in Experimental Example 4 with water, the carbon material and the cellulose nanofiber dispersion liquid (the weight ratio of the carbon material to cellulose nanofiber dispersion liquid was 1:1) were stirred with a homogenizer (manufactured by SMT Co., Ltd.) for 12 hours to crush and mix the mixture. Here, the crushing step (step S4 ) and the mixing step (step S5) of FIG. 4 were simultaneously performed in one step. This mixture was in the form of a slurry, which was suction-filtered using an ejector (manufactured by Shibata Scientific Technology Ltd.) to peel off the carbon material from the filter paper. Then, the carbon material was placed in a constant temperature bath and dried at 60° C. for 12 hours to prepare the carbon material of Experimental Example 2.

### Experimental Example 6

Experimental Example 6 is an experimental example of a carbon material (cellulose nanofiber carbon) prepared by the production method of the modification of the first embodiment (see FIG. 1).

In Experimental Example 6, the carbon material of Experimental Example 6 was prepared by peeling only the skin portion of the carbon material prepared in Experimental Example 4 with a cutter or the like. That is, the surface of the carbon material prepared in Experimental Example 4 was removed to prepare the carbon material of Experimental Example 6.

### Comparative Example 1

Comparative Example 1 is a carbon material produced by normal drying without performing the above semi-carbonization step.

In Comparative Example 1, the cellulose nanofiber dispersion liquid prepared in Experimental Example 1 was poured into a petri dish, placed in a constant temperature bath, and dried at 60° C. for 12 hours. Then, the cellulose nanofibers were carbonized by firing at 600° C. for 2 hours in a nitrogen atmosphere, whereby the carbon material of Comparative Example 1 was prepared.

### Comparative Example 2

In Comparative Example 2, after impregnating the carbon material produced in Comparative Example 1 (normal drying) with water, the carbon material and the cellulose nanofiber dispersion liquid (weight ratio of carbon material: cellulose nanofiber dispersion liquid was 1:1) were stirred with a homogenizer (manufactured by SMT Co., Ltd.) for 12 hours for crushing and mixing. This mixture was in the form of a slurry, which was suction-filtered using an ejector (manufactured by Shibata Scientific Technology Ltd.) to peel off the carbon material from the filter paper. Then, the carbon material was placed in a constant temperature bath and dried at 60° C. for 12 hours to prepare the carbon material of Comparative Example 2.

### Evaluation Method

The carbon materials obtained in Experimental Examples 1-6 and Comparative Examples 1 and 2 were evaluated by performing X-ray diffraction (XRD) measurement, SEM observation, porosity measurement, tensile test, and Brunauer Emmett Teller (BET) specific surface area measurement. It was confirmed by XRD measurement that this carbon material was single phase carbon (C, PDF card No. 01-071-4630). The PDF card No. is a card number of Powder Diffraction File (PDF), which is a database collected by the International Centre for Diffraction Data (ICDD).

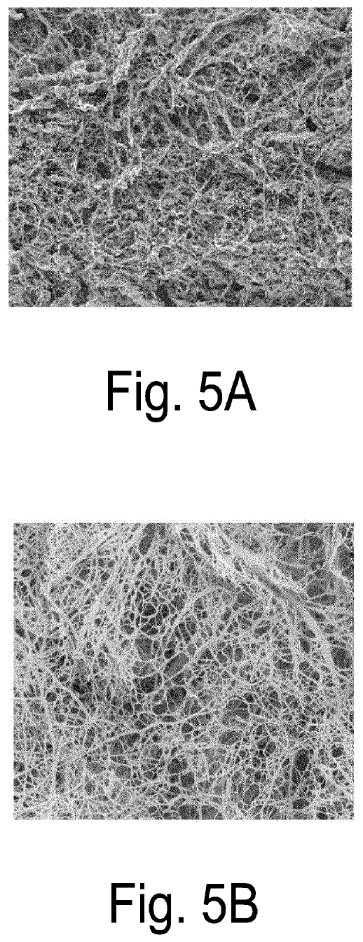

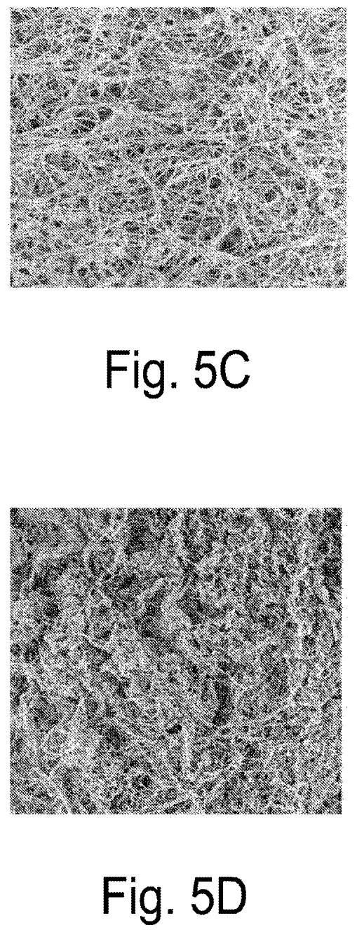

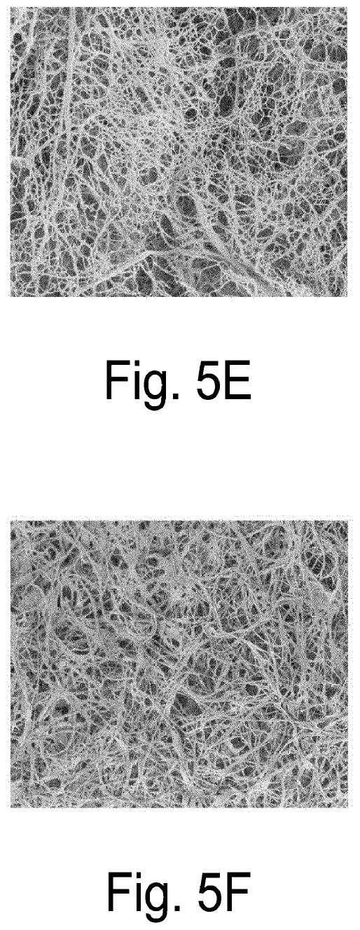

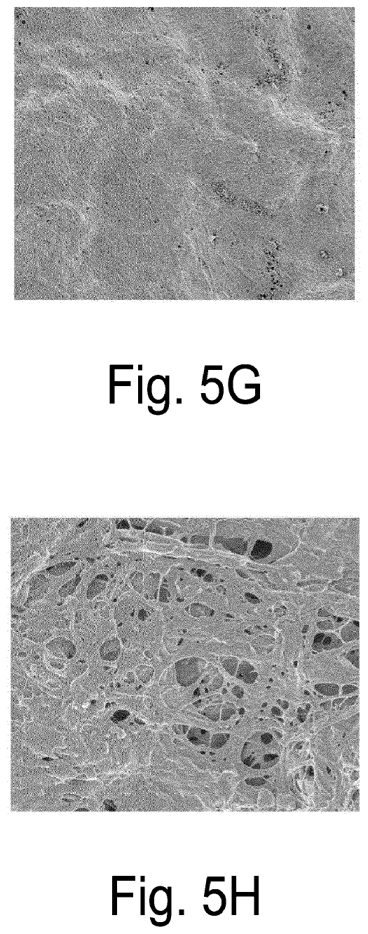

The SEM images of the produced carbon material are shown in FIGS. 5A to 5H. Table 1 shows the evaluation values obtained by measurement.

FIGS. 5A to 5C are SEM images of the carbon material obtained in Experimental Examples 1 to 3. FIG. 5A is an SEM image of the skin portion (surface) of the carbon material obtained in Experimental Example 1. As shown in FIG. 5A, the skin portion of the carbon material of Experimental Example 1 is partially aggregated. FIG. 5B is an SEM image of Experimental Example 3 and is an SEM image of a cross section cut to remove the skin portion of the carbon material of Experimental Example 1 (FIG. 5A). FIG. 5C is an SEM image of the surface of the carbon material obtained in Experimental Example 2.

FIGS. 5D to 5F are SEM images of the carbon material obtained in Experimental Examples 4 to 6. FIG. 5D is an SEM image of the skin portion (surface) of the carbon material obtained in Experimental Example 4. As shown in FIG. 5D, the skin portion of the carbon material of Experimental Example 4 is partially aggregated. FIG. 5E is an SEM image of Experimental Example 6 and is an SEM image of a cross section cut to remove the skin portion of the carbon material of Experimental Example 4 (FIG. 5D). FIG. 5F is an SEM image of the surface of the carbon material obtained in Experimental Example 5.

FIGS. 5G to 5H are SEM images of the carbon materials obtained in Comparative Examples 1 and 2. FIG. 5G is an SEM image of the surface of the carbon material obtained in Comparative Example 1. FIG. 5H is an SEM image of the surface of the carbon material obtained in Comparative Example 2. The magnification of the SEM images of FIGS. 5A to 5H is 10,000 times.

As shown in FIGS. 5A to 5C (Experimental Examples 1-3), it can be confirmed that the carbon materials obtained by the production methods of the first embodiment and the second embodiment are co-continuous body composed of continuous nanofibers having a fiber diameter of several tens of nm.

Similarly, as shown in FIGS. 5D to 5F (Experimental Examples 4 to 6), it can be confirmed that the carbon materials obtained by the production methods of the modification of the first embodiment and the modification of the second embodiment are co-continuous bodies in which nanofibers having a fiber diameter of several tens of nm are continuously connected.

On the other hand, as shown in FIGS. 5G and 5H (Comparative Examples 1 and 2), it can be confirmed that the carbon material in which the cellulose nanofiber dispersion liquid is normally dried is a carbon material having no pores and densely aggregated.

As shown in Table 1, the carbon materials of the first embodiment and the second embodiment (Experimental Examples 1 to 3) and the carbon materials of these modifications (Experimental Examples 4 to 6) can suppress aggregation due to surface tension of water due to evaporation of the dispersion medium, as compared with Comparative Examples 1 and 2 in which normal drying is performed. As a result, it was confirmed that it is possible to provide a carbon material having a high specific surface area and a high porosity and excellent performance.

Further, Experimental Example 3 is a carbon material produced by peeling off the skin portion (FIG. 5A) of the carbon material produced in Experimental Example 1. The SEM image of this Experimental Example 3 is FIG. 5B. Therefore, the carbon material of Experimental Example 3 has excellent performance having a high specific surface area and a high porosity. The reason for this is considered to be that, as shown in FIG. 5A, the skin portion of the carbon material obtained by the production method of Experimental Example 1 is partially aggregated, and the aggregates of the skin portion are removed.

Similarly, Experimental Example 6 is a carbon material produced by peeling off the skin portion (FIG. 5D) of the carbon material produced in Experimental Example 4. The SEM image of this Experimental Example 6 is FIG. 5E. Therefore, the carbon material of Experimental Example 6 has excellent performance having a high specific surface area and a high porosity. The reason for this is considered to be that, as shown in FIG. 5D, the skin portion of the carbon material obtained by the production method of Experimental Example 4 is partially aggregated, and the aggregates of the skin portion are removed.

TABLE 1

| Experimental | SEM | Specific | | | |
|---|---|---|---|---|---|
| Example/Comparative | Observation | Surface | | | |
| Example | Result | Area | | Porosity | Tensile Strength |
| Experimental | 20 nmϕ co- | 770 | m²/g | 90% or | Restored to its original shape |
| Example 1 | continuous body | | | more | even with 80% distortion |
| Experimental | 30 nmϕ co- | 500 | m²/g | 80% or | Confirmed that it can withstand |
| Example 2 | continuous body | | | more | tensile stress of 300 MPa |
| Experimental | 17 nmϕ co- | 990 | m²/g | 98% or | Restored to its original shape |
| Example 3 | continuous body | | | more | even with 80% distortion |
| Experimental | 20 nmϕ co- | 690 | m²/g | 90% or | Restored to its original shape |
| Example 4 | continuous body | | | more | even with 80% distortion |
| Experimental | 30 nmϕ co- | 400 | m²/g | 80% or | Confirmed that it can withstand |
| Example 5 | continuous body | | | more | tensile stress of 300 MPa |
| Experimental | 17 nmϕ co- | 800 | m²/g | 98% or | Restored to its original shape |
| Example 6 | continuous body | | | more | even with 80% distortion |
| Comparative | Aggregated | 1 | m²/g | 10% or | Fractured at a tensile stress of 1 |
| Example 1 | carbon material | | | less | MPa or less |
| | without pores | | | | |
| Comparative | Aggregated | 5 | m²/g | 10% or | — |
| Example 2 | carbon material | | | less | |
| | without pores | | | | |

As shown in Table 1, in Experimental Examples 1 and 3, it was confirmed that the material had excellent elasticity even after carbonization. Further, in Experimental Example 2, it was confirmed that the material had excellent tensile strength.

As described above, in the first embodiment and the second embodiment, cellulose nanofiber carbon having excellent specific surface area, strength, and porosity can be obtained for the reason described below. The reason for this is as follows: the production method of the present embodiment includes a semi-carbonization step of semi-carbonizing the dispersion liquid containing cellulose nanofibers with a heat medium to obtain a semi-carbonized product, and a carbonization step of heating and carbonizing the semi-carbonized product in an atmosphere that does not burn it, in which the cellulose nanofibers are carbonized by heat treatment. That is, the cellulose nanofiber carbon of the present embodiment has elasticity, high mechanical strength, and a large specific surface area.

Similarly, as shown in Table 1, it was confirmed that the material had excellent elasticity even after carbonization in Experimental Examples 4 and 6. Further, in Experimental Example 5, it was confirmed that the material had excellent tensile strength.

As described above, in the modifications of the first embodiment and the second embodiment, cellulose nanofiber carbon having excellent specific surface area, strength, and porosity can be obtained for the reason described below. The reason for this is as follows: the production method of the present embodiment includes a semi-carbonization step of semi-carbonizing the dispersion liquid containing cellulose nanofibers by hydrothermal synthesis to obtain a semi-carbonized product, and a carbonization step of heating and carbonizing the semi-carbonized product in an atmosphere that does not burn it, in which the cellulose nanofibers are carbonized by heat treatment. That is, the cellulose nanofiber carbon in the present modification has elasticity, high mechanical strength, and a large specific surface area.

The carbon material produced by the production methods of the first embodiment, the second embodiment, and these modifications may be cellulose derived from a natural product, the environmental load of which is extremely low. Since these carbon materials are easily disposable in daily life, they can be effectively used in various situations such as small devices, sensor terminals, medical equipment, batteries, beauty appliances, fuel cells, biofuel cells, microbial batteries, capacitors, catalysts, solar cells, semiconductor production processes, filters, heat resistant materials, flame resistant materials, heat insulating materials, conductive materials, electromagnetic wave shield materials, electromagnetic wave noise absorbents, heating elements, microwave heating elements, cone paper, clothes, carpet, mirror anti-fog materials, sensors, and touch panels.

### Third Embodiment

In the third embodiment and the fourth embodiment described later, a gel containing cellulose nanofibers is used instead of the cellulose nanofiber dispersion liquid (dispersion liquid containing cellulose nanofibers) of the first embodiment. Further, the gels of the third embodiment and the fourth embodiment are bacterial gels in which cellulose nanofibers are dispersed using bacteria. Therefore, the cellulose nanofiber carbon produced by the production methods of the third embodiment and the fourth embodiment will be referred to as “bacterial cellulose carbon” in the following description.

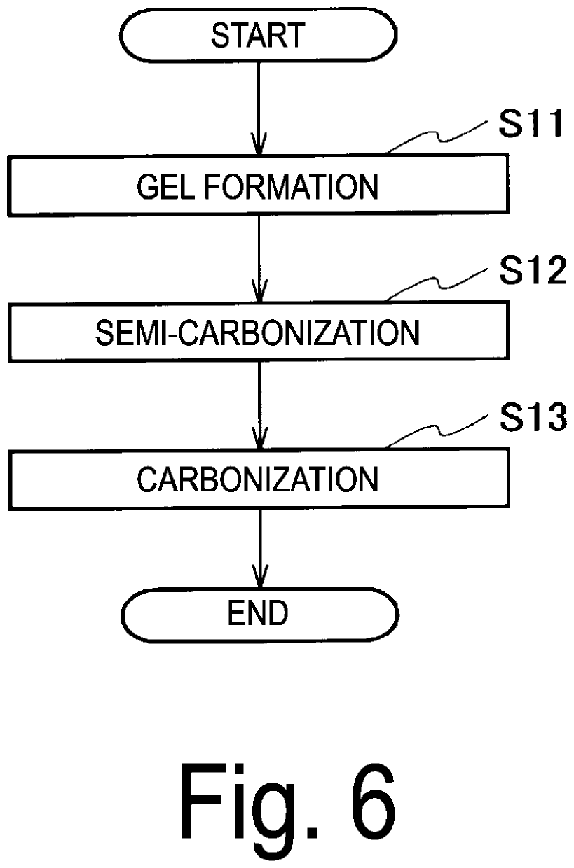

FIG. 6 is a flowchart depicting a method for producing bacterial cellulose carbon according to the third embodiment of the present invention. In the following description, bacterial cellulose carbon may be referred to as “carbon material”.

The method for producing bacterial cellulose carbon of the present embodiment includes a gel formation step (step S11), a semi-carbonization step (step S12), and a carbonization step (step S14).

In the gel formation step, a bacterial gel in which cellulose nanofibers are dispersed using bacteria is formed (step S11). Here, the gel means a gel in which the dispersion medium loses fluidity due to the three-dimensional network structure of the nanostructure which is a dispersoid and becomes a solid state. Specifically, gel means a dispersion system having a shear modulus of 10² to 10⁶ Pa. The dispersion medium of the gel may be one or a mixture of two or more of aqueous ones such as (H₂O) and organic ones such as carboxylic acid, methanol (CH₃OH), ethanol (C₂H₅OH), propanol (C₃H₇ OH), n-butanol, isobutanol, n-butylamine, dodecane, unsaturated fatty acids, ethylene glycol, heptane, hexadecane, isoamyl alcohol, octanol, isopropanol, acetone, and glycerin.

The gel produced by bacteria has a basic structure of nanofibers on the order of nm, and by producing a carbon material using this gel, the obtained carbon material has a high specific surface area. Specifically, by using a gel produced by bacteria, it is possible to synthesize a carbon material having a specific surface area of 300 m²/g or more.

Bacterial gel has a structure in which nanofibers are entwined in a coil or mesh shape, and has a structure in which nanofibers are branched based on the growth of bacteria. Therefore, the produced carbon material realizes excellent elasticity with a strain at the elastic limit of 50% or more.

Examples of bacteria include known ones such as those produced by culturing acetobacter such as Acetobacter xylinum subspecies sucrofermentans, Acetobacter xylinum ATCC23768, Acetobacter xylinum ATCC23769, Acetobacter pasturianus ATCC10245, Acetobacter xylinum ATCC14851, Acetobacter xylinum ATCC11142, and Acetobacter xylinum ATCC10821. Further, the bacteria may also be produced by culturing various mutant strains created by mutating these acetic acid bacteria by a known method using NTG (nitrosoguanidine) or the like.

In the semi-carbonization step, the bacterial gel is semi-carbonized to obtain a semi-carbonized product (step S12). In the semi-carbonization step, for example, the bacterial gel is impregnated in silicone oil heated to 250° C., the dispersion medium contained in the bacterial gel is vaporized, and then the heat treatment is continued. The method for semi-carbonization is not particularly limited as long as it can semi-carbonize the bacterial gel. The heat medium may be one or a mixture of two or more of silicone oils, polyhydric alcohols, phenols and phenolic ethers, polyphenyls, chlorinated benzene and polyphenyls, siliceous esters, fractionated tars and petroleum, edible oils, and the like.

The temperature of the heat medium varies depending on the heat medium used, but is not particularly limited as long as the bacterial gel is semi-carbonized at the temperature. For example, when silicone oil is used as the heat medium and water is used as the dispersion medium for the bacterial gel, impregnating the bacterial gel with silicone oil at 200° C. causes the water in the dispersion medium to be rapidly vaporized, and then semi-carbonization of the bacterial gel is started. Since the semi-carbonization temperature of the bacterial gel is about 200° C., the temperature of the heat medium is preferably 200° C. or higher.

Further, after semi-carbonization, since the heat medium is contained in the semi-carbonized bacterial gel, a washing step of washing with water, alcohol or the like may be included.

By semi-carbonizing the bacterial gel, the dispersoid is fixed, and the cellulose nanofibers that maintain the three-dimensional network structure can be taken out.

In the carbonization step, the semi-carbonized product is heated and carbonized in an atmosphere that does not burn the semi-carbonized product to obtain bacterial cellulose carbon (step S13). The semi-carbonized bacterial gel may be carbonized by firing at 500° C. to 2000° C., more preferably from 900° C. to 1800° C. in an inert gas atmosphere. The gas that does not burn cellulose may be, for example, an inert gas such as nitrogen gas or argon gas. Further, the gas that does not burn cellulose may be a reducing gas such as hydrogen gas or carbon monoxide gas, or may be carbon dioxide gas. In the present embodiment, carbon dioxide gas or carbon monoxide gas, which has an activating effect on the carbon material and can be expected to be highly activated, is more preferable.

According to the method for producing bacterial cellulose carbon described above, the cellulose nanofibers which are dispersoids are fixed by the semi-carbonization step, and the cellulose nanofibers that maintain a three-dimensional network structure can be taken out. Therefore, a sufficient specific surface area can be obtained, and a carbon material having a high specific surface area can be easily produced.

That is, the bacterial cellulose carbon produced in the present embodiment has a three-dimensional network structure of a co-continuous body in which a plurality of nanofibers of a bacterial gel integrated by non-covalent bonds are connected. The co-continuous body is a porous body and has an integral structure. The co-continuous body of the three-dimensional network structure in which a plurality of nanofibers are integrated by non-covalent bonds has an elastic structure in which the bonding portion between the nanofibers are deformable.

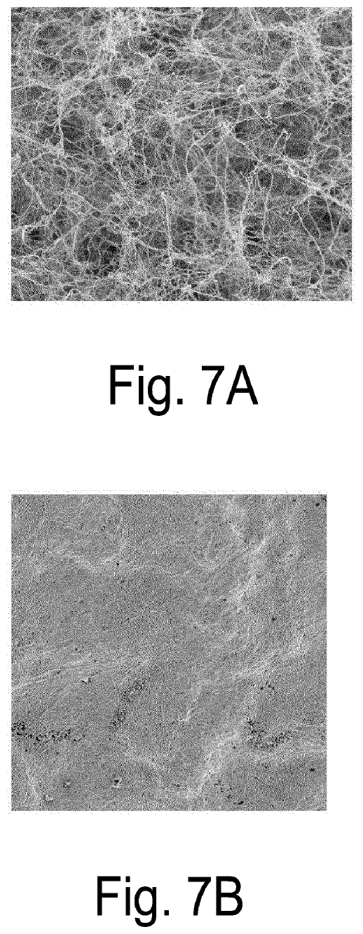

FIGS. 7A and 7B are SEM images of bacterial cellulose carbon. The magnification is 10,000 times.

FIG. 7A is an SEM image of bacterial cellulose carbon produced by the production method of the present embodiment. The image shows that the cellulose nanofibers are fixed and a three-dimensional network structure is constructed.

FIG. 7B shows the state of bacterial cellulose carbon when the bacterial gel is dried and carbonized in the air, unlike the production method of the present embodiment. During drying, the bacterial cellulose gel is affected by the surface tension of the dispersion medium, and the unimmobilized cellulose nanofibers aggregate, so that the three-dimensional network structure of the cellulose nanofibers is destroyed. As shown in FIG. 7B, if the three-dimensional network structure is destroyed, it is difficult to prepare a carbon material having a high specific surface area.

As described above, the bacterial cellulose carbon produced by the production method of the present embodiment is a carbon material having a three-dimensional network structure and elasticity. In addition, the bacterial cellulose carbon of the present embodiment has high conductivity, corrosion resistance, and a high specific surface area.

Therefore, the bacterial cellulose carbon produced by the production method of the present embodiment can improve the adhesion to electrodes, voids, biological tissues, device connection portions, and the like.

Since the bacterial cellulose carbon of the present embodiment has high conductivity, corrosion resistance, and a high specific surface area, they are suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbents, heating elements, microwave heating elements, cone paper, clothes, carpets, mirror anti-fog materials, sensors, and touch panels.

### Modification of Third Embodiment

The method for producing bacterial cellulose carbon in the present modification is the same as that in the third embodiment, except that hot water having high temperature and high pressure is used as the heat medium used in the semi-carbonization step in the production method of the third embodiment depicted in FIG. 6.

Specifically, as depicted in FIG. 6, the method for producing bacterial cellulose carbon in the present modification includes a gel formation step (step S11), a semi-carbonization step (step S12), and a carbonization step (step S14). Since the gel formation step and the carbonization step are the same as those in the third embodiment, description thereof will be omitted here.

In the semi-carbonization step in the present modification, the bacterial gel is semi-carbonized to obtain a semi-carbonized product (step S12). The semi-carbonization step is carried out, for example, by placing a bacterial gel in a hydrothermal synthesis container, self-pressurizing, and heat-treating at 250° C. The method for semi-carbonization is not particularly limited as long as it can semi-carbonize the bacterial gel. However, since the semi-carbonizing temperature of the bacterial gel is about 200° C., the temperature is preferably 200° C. or higher.

By semi-carbonizing the bacterial gel, the dispersoid is fixed, and the cellulose nanofibers that maintain the three-dimensional network structure can be taken out.

According to the method for producing bacterial cellulose carbon in the present embodiment, cellulose nanofibers that are dispersoids are fixed by the semi-carbonization step, and cellulose nanofibers that maintain a three-dimensional network structure can be taken out. Therefore, a sufficient specific surface area can be obtained, and a carbon material having a high specific surface area can be easily produced.

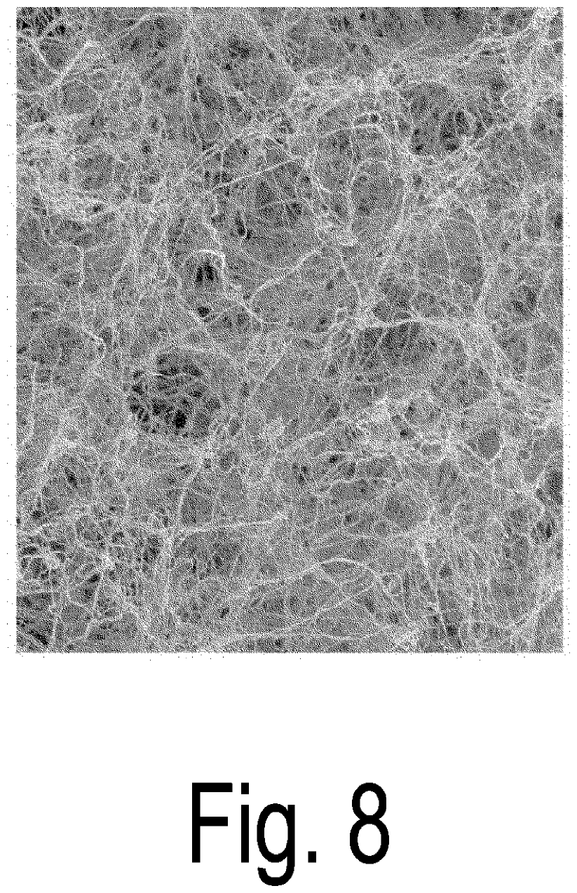

FIG. 8 is an SEM image of bacterial cellulose carbon produced by the production method in the present modification. The magnification is 10,000 times. The image shows that the cellulose nanofibers are fixed and a three-dimensional network structure is constructed.

As in the third embodiment, the bacterial cellulose carbon produced by the production method of the present modification has a three-dimensional network structure and is a carbon material having elasticity. In addition, the bacterial cellulose carbon in the present modification has high conductivity, corrosion resistance, and a high specific surface area.

Therefore, the bacterial cellulose carbon produced by the production method in the present modification can improve the adhesion to electrodes, voids, biological tissues, device connection portions, and the like.

Since the bacterial cellulose carbon of the present embodiment has high conductivity, corrosion resistance, and a high specific surface area, they are suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbents, heating elements, microwave heating elements, cone paper, clothes, carpets, mirror anti-fog materials, sensors, and touch panels.

### Fourth Embodiment

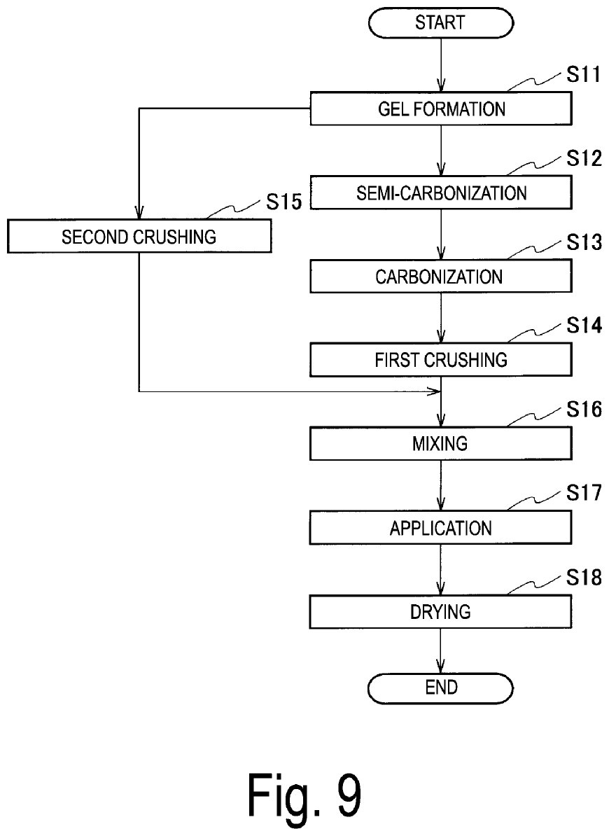

FIG. 9 is a flowchart depicting a method for producing bacterial cellulose carbon according to the fourth embodiment. The production method depicted in FIG. 9 is the production method of the third embodiment which further includes a first crushing step (step S14), a second crushing step (step S15), a mixing step (step S16), an application step (step S17), and a drying step (step S18).

In the first crushing step, the dried body (bacterial cellulose carbon) carbonized in the above carbonization step (step S13) is crushed (step S14). In the first crushing step, bacterial cellulose carbon is crushed into powder or slurry using, for example, a mixer, a homogenizer, an ultrasonic homogenizer, a high-speed rotary shear type stirrer, a colloid mill, a roll mill, a high-pressure injection disperser, a rotary ball mill, a vibrating ball mill, a planetary ball mill, or an attritor.

In this case, the bacterial cellulose carbon preferably has a secondary particle size of from 100 nm to 5 mm, and more preferably from 1 um to 1 mm The reason for this is as follows: when cellulose carbon is crushed to a secondary particle size of 100 nm or less, the co-continuous structure of cellulose nanofibers is broken, it becomes difficult to obtain sufficient binding force and conductive path, and electrical resistance increases. Further, when the secondary particle diameter is 5 mm or more, the bacterial gel that functions as a binder does not disperse sufficiently, and it becomes difficult to maintain the sheet shape.

Further, since the bacterial cellulose carbon has a high porosity and a low density, when the carbon material is crushed by itself, the powder of the bacterial cellulose carbon flies during or after the crushing, which makes it difficult to handle. Therefore, it is preferable to impregnate the bacterial cellulose carbon with a liquid and then crush the carbon. The liquid used here is not particularly limited, and may, for example, be one or a mixture of two or more of aqueous ones such as (H₂O) and organic ones such as carboxylic acid, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, and glycerin.

In the second crushing step, the bacterial gel formed in the gel formation step is crushed (step S15). It is also possible to crush the bacterial gel and the bacterial cellulose carbon at the same time. That is, the first crushing step and the second crushing step can be performed at the same time. In that case, the mixing step can be omitted.

In the mixing step, the materials crushed in each of the first crushing step and the second crushing step are mixed (step S16). The mixture is in the form of a slurry.

In the application step, a slurry-like mixture is formed into a desired shape (step S17).

In the drying step, the liquid is removed from the mixture formed (applied) in a predetermined shape in the application step (step S18). When drying the slurry-like mixture (mixed slurry), a constant temperature bath, a vacuum dryer, an infrared dryer, a hot air dryer, a suction dryer, or the like may be used. Further, by performing suction filtration using an aspirator or the like, it can be dried quickly.

The mixed slurry obtained by the production method of the present embodiment described above may be dried without performing an application step to form a sheet, and then processed into a desired shape. By forming the mixed slurry into a predetermined shape and then drying it, the sheet-shaped carbon material can be processed into a desired shape. Further, by applying in the application step, it is possible to reduce the material cost such as scraps generated in the cutting process, and it is possible to obtain a carbon material having a shape according to the user's preference. In addition, the strength of the carbon material can be increased.

The production method of the present embodiment does not have to include all the steps. For example, bacterial cellulose carbon subjected to the first crushing step may be used in the crushed state. The term “used” means to be distributed in that state. Similarly, the bacterial cellulose carbon subjected to the mixing step may be distributed in the state of a mixed slurry.

### Modification of Fourth Embodiment

The method for producing bacterial cellulose carbon in the present modification is the same as that in the second embodiment, except that hot water having high temperature and high pressure is used as the heat medium used in the semi-carbonization step in the production method of the fourth embodiment depicted in FIG. 9.

Specifically, the method for producing bacterial cellulose carbon in the present modification is the production method of the modification of the third embodiment using hot water at high temperature and high pressure as the heat medium of the semi-carbonization step, which further includes a first crushing step (step S14), a second crushing step (step S15), a mixing step (step S16), an application step (step S17), and a drying step (step S18).

Since the first crushing step, the second crushing step, the mixing step, the application step, and the drying step in the present modification are the same as those of the fourth embodiment, the description thereof will be omitted here.

### Experimental Examples of Third and Fourth Embodiments, and Modification

For the purpose of confirming the effects of the production methods of the third embodiment and the fourth embodiment described above, an experiment was carried out for comparing the carbon materials produced by the production methods of the third embodiment and the fourth embodiment (Experimental Examples 1 to 3) and carbon materials produced by production methods different from that of the embodiments (Comparative Examples 1 and 2). Further, the same experiment was also performed on the carbon materials (Experimental Examples 4 to 6) produced by the production methods of the modification of the third embodiment and the modification of the fourth embodiment.

### Experimental Example 1

Experimental Example 1 is an experimental example of a carbon material (bacterial cellulose carbon) prepared by the production method of the third embodiment (see FIG. 6).

Using Nata de coco (manufactured by Fujicco Co., Ltd.) as a bacterial cellulose gel produced by Acetobacter xylinum, which is an acetic acid bacterium, the water contained in the bacterial gel was completely vaporized by immersing the bacterial gel in silicone oil heated to 250° C. for 24 hours, and the bacterial gel was semi-carbonized. After completely semi-carbonizing the bacterial gel, the semi-carbonized bacterial gel was taken out and washed with ultrapure water.

After washing, the semi-carbonized bacterial gel was carbonized by firing at 600° C. for 2 hours in a nitrogen atmosphere, whereby the carbon material of Experimental Example 1 was prepared.

### Experimental Example 2

Experimental Example 2 is an experimental example of a carbon material (bacterial cellulose carbon) prepared by the production method of the fourth embodiment (see FIG. 9).

In Experimental Example 2, after impregnating water with the carbon material prepared in Experimental Example 1, the carbon material and the bacterial gel (the weight ratio of the carbon material to bacterial gel was 1:1) were stirred with a homogenizer (manufactured by SMT Co, Ltd.) for 12 hours to crush and mix the mixture. Here, the first crushing step (step S14), the second crushing step (step S15), and the mixing step (step S16) of FIG. 7 were simultaneously performed in one step.

This mixture was in the form of a slurry, which was suction-filtered using an ejector (manufactured by Shibata Scientific Technology Ltd.) to peel off the carbon material from the filter paper. Then, the carbon material was placed in a constant temperature bath and dried at 60° C. for 12 hours to prepare the carbon material of Experimental Example 2.

### Experimental Example 3

Experimental Example 3 is an experimental example of a carbon material (bacterial cellulose carbon) prepared by the production method of the third embodiment (see FIG. 6).

In Experimental Example 3, the carbon material was prepared by peeling only the skin portion of the carbon material produced in Experimental Example 1 with a cutter or the like. That is, the surface of the carbon material prepared in Experimental Example 1 was removed to prepare the carbon material of Experimental Example 3.

### Experimental Example 4

Experimental Example 4 is an experimental example of a carbon material (bacterial cellulose carbon) prepared by the production method of the modification (see FIG. 6) of the third embodiment.

Using Nata de coco (manufactured by Fujicco Co., Ltd.) as a bacterial cellulose gel produced by Acetobacter xylinum, which is an acetic acid bacterium, the above bacterial gel was placed in a hydrothermal synthesis container, self-pressurized, and heated at 250° C. to semi-carbonize the bacterial gel.

After semi-carbonization, the semi-carbonized bacterial gel was carbonized by firing at 600° C. for 2 hours in a nitrogen atmosphere, whereby the carbon material of Experimental Example 4 was prepared.

### Experimental Example 5

Experimental Example 5 is an experimental example of a carbon material (bacterial cellulose carbon) prepared by the production method of the modification (see FIG. 9) of the fourth embodiment.

After impregnating the carbon material prepared in Experimental Example 4 with water, the carbon material and the bacterial gel (the weight ratio of the carbon material to bacterial gel was 1:1) were stirred with a homogenizer (manufactured by SMT Co., Ltd.) for 12 hours to crush and mix the mixture. This mixture was in the form of a slurry, which was suction-filtered using an ejector (manufactured by Shibata Scientific Technology Ltd.) to peel off the carbon material from the filter paper. Then, the carbon material was placed in a constant temperature bath and dried at 60° C. for 12 hours to prepare the carbon material of Experimental Example 5.

### Experimental Example 6

Experimental Example 6 is an experimental example of a carbon material (bacterial cellulose carbon) prepared by the production method of the third embodiment (see FIG. 6).

The carbon material of Experimental Example 6 was prepared by peeling only the skin portion of the carbon material prepared in Experimental Example 4 with a cutter.

### Comparative Example 1

Comparative Example 1 is a carbon material (bacterial cellulose carbon) produced by normal drying without performing the above-mentioned semi-carbonization step.

In Comparative Example 1, the bacterial gel used in Experimental Example 1 was placed in a constant temperature bath and dried at 60° C. for 12 hours. Then, the bacterial cellulose was carbonized by firing at 600° C. for 2 hours in a nitrogen atmosphere, whereby the carbon material of Comparative Example 1 was prepared.

### Comparative Example 2

In Comparative Example 2, the carbon material prepared in Comparative Example 1 (normally dried) was impregnated with water and then crushed by stirring with Homo Energy (manufactured by SMT Co., Ltd.) for 12 hours to prepare a slurry in which the carbon material was dispersed. Then, the slurry and the bacterial gel (the weight ratio of carbon material to bacterial gel was 1:1) were stirred for 12 hours for crushing and mixing the mixture.

Then, suction filtration was performed using an aspirator (manufactured by Shibata Scientific Technology Ltd.) to peel off the carbon material from the filter paper. Then, the carbon material was placed in a constant temperature bath and dried at 60° C. for 12 hours to prepare the carbon material of Comparative Example 2.

### Evaluation Method

The carbon materials obtained in Experimental Examples 1 to 6 and Comparative Examples 1 and 2 were evaluated by performing XRD measurement, SEM observation, porosity measurement, tensile test, and BET specific surface area measurement. It was confirmed by XRD measurement that this carbon material was single phase carbon (C, PDF card No. 01-071-4630). The PDF card No. is a card number of Powder Diffraction File (PDF), which is a database collected by the International Centre for Diffraction Data (ICDD).

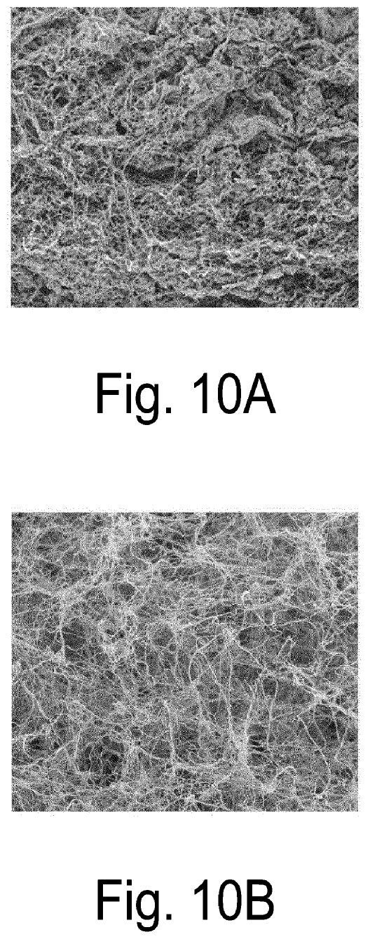

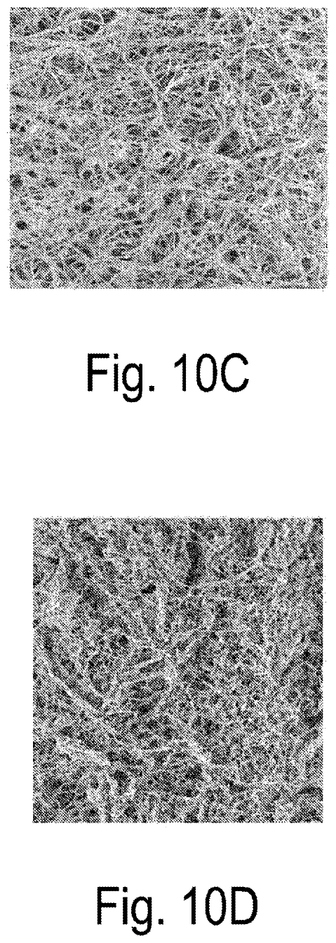

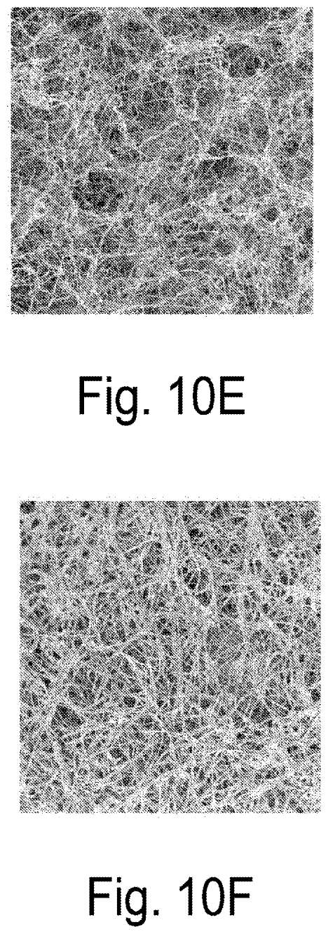

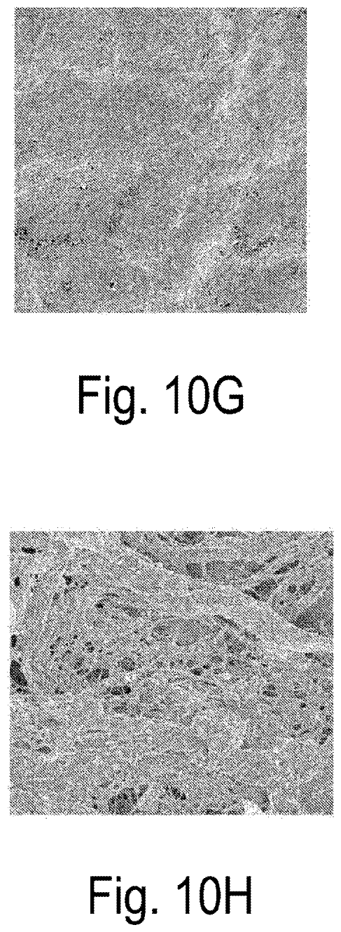

The SEM images of the produced carbon material are shown in FIGS. 10A to 10H. Table 2 shows the evaluation values obtained by measurement.

FIGS. 10A to 10C are SEM images of the carbon material obtained in Experimental Examples 1 to 3. FIG. 10A is an SEM image of the skin portion (surface) of the carbon material obtained in Experimental Example 1. As shown in FIG. 10A, the skin portion of the carbon material of Experimental Example 1 is partially aggregated. FIG. 10B is an SEM image of Experimental Example 3, which is an SEM image of a cross section cut to remove the skin portion of the carbon material of FIG. 10A. FIG. 10C is an SEM image of the surface of the carbon material obtained in Experimental Example 2.

FIGS. 10D to 10F are SEM images of the carbon material obtained in Experimental Examples 4 to 6. FIG. 10D is an SEM image of the skin portion (surface) of the carbon material obtained in Experimental Example 4. As shown in FIG. 10D, the skin portion of the carbon material of Experimental Example 4 is partially aggregated. FIG. 10E is an SEM image of Experimental Example 6 and is an SEM image of a cross section cut to remove the skin portion of the carbon material of Experimental Example 4 (FIG. 10D). FIG. 10F is an SEM image of the surface of the carbon material obtained in Experimental Example 5.

FIGS. 10G to 10H are SEM images of the carbon materials obtained in Comparative Examples 1 and 2. FIG. 10G is an SEM image of the surface of the carbon material obtained in Comparative Example 1. FIG. 10E is an SEM image of the surface of the carbon material obtained in Comparative Example 2. The magnification of the SEM images of FIGS. 10A to 10H is 10,000 times.

As shown in FIGS. 10A to 10C (Experimental Examples 1 to 3), it can be confirmed that the carbon materials obtained by the production methods of the third embodiment and the fourth embodiment are co-continuous bodies in which nanofibers with a fiber diameter of several tens of nm are continuously connected.

Similarly, FIGS. 10D to 10F (Experimental Examples 4 to 6) show that the carbon materials obtained by the production methods of the modification of the third embodiment and the modification of the fourth embodiment are co-continuous bodies in which nanofibers with a fiber diameter of several tens of nm are continuously connected.

On the other hand, FIGS. 10G and 10H (Comparative Examples 1 and 2) show that the carbon material obtained by normally drying a water-containing bacterial gel is a carbon material having no pores and densely aggregated.

As shown in Table 2, the carbon materials of the third and fourth embodiments (Experimental Examples 1 to 3) and the carbon materials of these modifications (Experimental Examples 4 to 6) can suppress aggregation due to surface tension of water due to evaporation of the dispersion medium as compared with the drying steps of Comparative Examples 1 and 2 in which normal drying is performed. As a result, it was confirmed that it is possible to provide a carbon material having a high specific surface area and a high porosity and excellent performance.

Further, Experimental Example 3 is a carbon material produced by peeling off the skin portion (FIG. 10A) of the carbon material produced in Experimental Example 1. The SEM image of this Experimental Example 3 is FIG. 10B. Therefore, the carbon material of Experimental Example 3 has excellent performance having a high specific surface area and a high porosity. The reason for this is considered to be that, as shown in FIG. 10A, the skin portion of the carbon material obtained by the production method of Experimental Example 1 is partially aggregated, and the aggregates of the skin portion are removed.

Similarly, Experimental Example 6 is a carbon material produced by peeling off the skin portion (FIG. 10D) of the carbon material produced in Experimental Example 4. The SEM image of this Experimental Example 6 is FIG. 10E. Therefore, the carbon material of Experimental Example 6 has excellent performance having a high specific surface area and a high porosity. The reason for this is considered to be that, as shown in FIG. 10D, the skin portion of the carbon material obtained by the production method of Experimental Example 4 is partially aggregated, and the aggregates of the skin portion are removed.

TABLE 2

| Experimental | SEM | Specific | | | |
|---|---|---|---|---|---|
| Example/Comparative | Observation | Surface | | | |
| Example | Result | Area | | Porosity | Tensile Strength |
| Experimental | 16 nmφ co- | 800 | m²/g | 90% or | Restored to its original shape |
| Example 1 | continuous body | | | more | even with 80% distortion |
| Experimental | 30 nmϕ co- | 550 | m²/g | 80% or | Confirmed that it can withstand |
| Example 2 | continuous body | | | more | tensile stress of 300 MPa |
| Experimental | 16 nmϕ co- | 1010 | m²/g | 98% or | Restored to its original shape |
| Example 3 | continuous body | | | more | even with 80% distortion |
| Experimental | 16 nmϕ co- | 720 | m²/g | 90% or | Restored to its original shape |
| Example 4 | continuous body | | | more | even with 80% distortion |
| Experimental | 30 nmϕ co- | 410 | m²/g | 80% or | Confirmed that it can withstand |
| Example 5 | continuous body | | | more | tensile stress of 300 MPa |
| Experimental | 16 nmϕ co- | 980 | m²/g | 98% or | Restored to its original shape |
| Example 6 | continuous body | | | more | even with 80% distortion |
| Comparative | Aggregated | 1 | m²/g | 10% or | Fractured at tensile stress of 1 |
| Example 1 | carbon material | | | less | MPa or less |
| | without pores | | | | |
| Comparative | Aggregated | 5 | m²/g | 10% or | — |
| Example 2 | carbon material | | | less | |
| | without pores | | | | |

As shown in Table 2, in Experimental Examples 1 and 3, it was confirmed that the material had excellent elasticity even after carbonization. Further, in Experimental Example 2, it was confirmed that the material had excellent tensile strength.

As described above, the production methods of the third embodiment and the fourth embodiment include a semi-carbonization step of semi-carbonizing a bacterial gel with a heat medium to obtain a semi-carbonized product, and a carbonization step of heating and carbonizing the semi-carbonized product in an atmosphere that does not burn it. Since the bacterial cellulose is carbonized by heat treatment, the bacterial cellulose carbon produced in the third and fourth embodiments can obtain excellent specific surface area, strength, and porosity. That is, the bacterial cellulose carbon of the present embodiment has elasticity, high mechanical strength, and a large specific surface area.

Similarly, as shown in Table 2, it was confirmed that Experimental Examples 4 and 6 had excellent elasticity even after carbonization. Further, in Experimental Example 5, it was confirmed that the material had excellent tensile strength.

As described above, the production methods of the modifications of the third embodiment and the fourth embodiment include a semi-carbonization step of semi-carbonizing a bacterial gel by hydrothermal synthesis to obtain a semi-carbonized product, and a carbonization step in which the semi-carbonized product is heated and carbonized in an atmosphere where the semi-carbonized product does not burn. Since the bacterial cellulose is carbonized by heat treatment, the bacterial cellulose carbon produced in the modifications of the third embodiment and the fourth embodiment has an excellent specific surface area, strength, and porosity. That is, the bacterial cellulose carbon in the present modification has elasticity, high mechanical strength, and a large specific surface area.

The carbon material produced by the production methods of the third embodiment, the fourth embodiment, and these modifications may use cellulose derived from a natural product, and thus has an extremely low environmental load. Since these carbon materials are easily disposable in daily life, they can be effectively used in various situations such as small devices, sensor terminals, medical equipment, batteries, beauty appliances, fuel cells, biofuel cells, microbial batteries, capacitors, catalysts, solar cells, semiconductor production processes, filters, heat resistant materials, flame resistant materials, heat insulating materials, conductive materials, electromagnetic wave shield materials, electromagnetic wave noise absorbents, heating elements, microwave heating elements, cone paper, clothes, carpet, mirror anti-fog materials, sensors, and touch panels.

The present disclosure is not limited to the above embodiment, and can be modified within the scope of the gist thereof.

For example, as described in Example 3 of Tables 1 and 2, the carbonization step of the first and third embodiments (see FIGS. 1 and 6) may be followed by a removal step in which only the skin portion of the carbon material produced in the carbonization step is peeled off using a cutter or the like.

Similarly, the carbonization step of the second embodiment and the fourth embodiment (see FIG. 4: S3 and FIG. 9: S13) may be followed by a removal step in which only the skin part of the carbon material produced in the carbonization step is peeled off using a cutter or the like, and then the subsequent steps.

### REFERENCE SIGNS LIST

S1 Dispersion step
S2 Semi-carbonization step
S3 Carbonization step
S4 Crushing step
S5 Mixing step
S6 Drying step
S11 Gel formation step
S12 Semi-carbonization step
S13 Carbonization step
S14 First crushing step
S15 Second crushing step
S16 Mixing step
S17 Application step
S18 Drying step

1. A method for producing cellulose nanofiber carbon by carbonizing cellulose nanofibers, the method comprising:
semi-carbonizing a dispersion liquid or gel containing cellulose nanofibers with a heat medium to obtain a semi-carbonized product; and
heating and carbonizing the semi-carbonized product in an atmosphere that does not burn the semi-carbonized product to obtain cellulose nanofiber carbon.

2. The method for producing cellulose nanofiber carbon according to claim 1, wherein the heat medium is hot water at high temperature and high pressure.

3. The method for producing cellulose nanofiber carbon according to claim 1 or 2, further comprising crushing the carbonized cellulose nanofiber carbon.

4. The method for producing cellulose nanofiber carbon according to claim 3, further comprising:
mixing the crushed cellulose nanofiber carbon and a dispersion liquid containing the cellulose nanofibers to obtain a mixed solution; and
removing liquid from the mixed solution.

5. The method for producing cellulose nanofiber carbon according to claim 1 or 2, further comprising dispersing the cellulose nanofibers using bacteria to form the gel.

6. The method for producing cellulose nanofiber carbon according to claim 5, further comprising:
crushing the carbonized cellulose nanofiber carbon;
crushing the formed gel; and
mixing the crushed cellulose nanofiber carbon with the crushed gel to obtain a mixture.

7. The method for producing cellulose nanofiber carbon according to claim 6, further comprising:
applying the mixture to form a predetermined shape; and
removing liquid from the mixture.

8. Cellulose nanofiber carbon comprising a three-dimensional network structure of a co-continuous body in which cellulose nanofibers are connected.
